(19) United States
(12) Patent Application Publication
(10) Pub. No.: US 2016/0131936 A1
(43) Pub. Date: May 12, 2016

(54) LIQUID CRYSTAL DISPLAY PANEL AND METHOD OF MANUFATURING SAME

(71) Applicant: SHENZHEN CHINA STAR OPTOELECTRONICS TECHNOLOGY CO., LTD., Guangdong (CN)

(72) Inventors: Xinhui Zhong, Guangdong (CN); Yung-Jui Lee, Guangdong (CN)

(21) Appl. No.: 14/416,170

(22) PCT Filed: Nov. 14, 2014
(86) PCT No.: PCT/CN2014/091064

§ 371 Date: Jan. 21, 2015

(30) Foreign Application Priority Data
Nov. 11, 2014 (CN) 201410630886.8

(51) Int. Cl. G02F 1/1333; G02F 1/1335; G02F 1/1339; G02F 1/1343

(52) U.S. Cl. CPC G02F 1/133365; G02F 1/134363; G02F 1/133514; G02F 1/133528; G02F 1/1339; G02F 2001/133302

(57) ABSTRACT

A liquid crystal display panel and a manufacturing method thereof are provided, which comprises a glass substrate provided with a color filter film or a dynamic flashing backlight module; a liquid crystal-polymer layer coated on the glass substrate; an upper polarizer and a lower polarizer respectively attached to the outer sides of the liquid crystal-polymer layer and the glass substrate. The liquid crystal display does not require the support of dual substrates, thereby improving transmittance, increasing light utilization, and being suitable for a device with an extremely rapid response, such as a device of field sequence display mode and so on.

### FIELD OF THE INVENTION

The present invention relates to a field for displays, and in particular to liquid crystal display panels and the manufacturing method thereof.

### BACKGROUND OF THE INVENTION

Active TFT-LCD (Thin Film Transistor-Liquid Crystal Display) apparatus have been being rapidly developed and widely applied in recent years. In the mainstream market, TFT-LCD panels can be respectively divided into three categories, TN/STN (Twisted Nematic/Super Twisted Nematic), IPS (In-Plane Switching), and VA (Vertical Alignment). Though the principles of the three TFT-LCD panels regulating the three liquid crystal displays are different, the basic structures of the liquid crystal display panels are relatively similar, which sequentially comprise: an upper polarizer 11, a color filter substrate 12, a liquid crystal layer 13, an array substrate 14, and a lower polarizer 15, as shown in FIG. 1.

The light utilization of the LCD is low. Since the panel itself does not emit light, to provide a light source from the backlight is required. In addition, the LCD has a low transmittance, and hence most of the backlight is wasted. The low transmittance of the LCD results from a number of factors, including the polarizer, the color filter film, the electrodes, etc., which have the effects of shielding and absorption of light. In order to improve the light utilization of the LCD, a field sequence color display LCD has been invented. The LCD does not have a color filter, and color is directly provided by the backlight of cyclic multicolor, such as RGB (red, green, and blue). Therefore, the transmittance and the light utilization can be theoretically increased up to 3 times.

However, the field sequence color display LCD requires a panel with an extremely rapid response. Currently, almost only the type of blue phase liquid crystal display is qualified, but the technical problems of narrow processing temperature and high driving voltage exist in the manufacturing process of the blue phase liquid crystal display. Therefore, developing a new rapid response LCD mode is urgently required.

### SUMMARY OF THE INVENTION

Hence, the present invention provides a liquid crystal display panel and the manufacturing method thereof to solve the problems of the low transmittance, light utilization, and the complicated process in the prior art.

To solve the technical problems above, an embodiment of the present invention provides the following technical solution:

A liquid crystal display panel is provided and comprises:
a glass substrate on which a comb-like electrode formed from a pixel electrode and a common electrode in a comb shape is disposed for generating a horizontal electric field, and a color filter film or a dynamic flashing backlight module is disposed;
a liquid crystal-polymer layer is formed by mixing a curable sealant with liquid crystal microcapsules, coated on the glass substrate, and cured by ultraviolet ray irradiation; and
an upper polarizer and a lower polarizer respectively attached to the outer sides of the liquid crystal-polymer layer and the glass substrate.

Preferably, the color filter film is disposed between the glass substrate and the liquid crystal polymer layer, or between the glass substrate and the upper polarizer.

Preferably, the dynamic flashing backlight module is located on a side close to a light source.

To solve the technical problems above, an embodiment of the present invention provides the following technical solution:
A liquid crystal display panel is provided and comprises:
a glass substrate on which a color filter film or a dynamic flashing backlight module is disposed;
a liquid crystal-polymer layer coated on the glass substrate; and
an upper polarizer and a lower polarizer respectively attached to the outer sides of the liquid crystal-polymer layer and the glass substrate.

Preferably, the color filter film is disposed between the glass substrate and the liquid crystal polymer layer, or between the glass substrate and the upper polarizer.

Preferably, the dynamic flashing backlight module is located on a side close to a light source.

Preferably, a comb-like electrode formed from a pixel electrode and a common electrode in a comb shape is disposed on the glass substrate for generating a horizontal electric field.

Preferably, the liquid crystal-polymer layer is formed by mixing a curable sealant with liquid crystal microcapsules, coated and cured by ultraviolet ray irradiation.

To solve the technical problems above, an embodiment of the present invention provides the following technical solution:

A method for manufacturing a liquid crystal display panel is provided and comprises steps of:
manufacturing a glass substrate on which a color filter film or a dynamic flashing backlight module is disposed;
manufacturing a liquid crystal-polymer;
forming a liquid crystal-polymer layer by coating the liquid crystal-polymer on a display area of the glass substrate; and curing the liquid crystal-polymer by ultraviolet ray irradiation; and
attaching an upper polarizer and a lower polarizer respectively to outer sides of the liquid crystal-polymer layer and the glass substrate.

Preferably, the step of disposing the color filter film on the substrate comprises: disposing the color filter film between the glass substrate and the liquid crystal-polymer layer, or between the glass substrate and the upper polarizer.

Preferably, the step of disposing the dynamic flashing backlight module on the substrate comprises: disposing the dynamic flashing backlight module on a side close to a light source, wherein the dynamic flashing backlight module comprises a general control module, a backlight control module, and a synchronization module of the liquid crystal display panel.

Preferably, the step of manufacturing the glass substrate comprises: disposing a comb-like electrode formed from a pixel electrode and a common electrode in a comb shape on the glass substrate, wherein the comb-like electrode is used for generating a horizontal electric field.

Preferably, the step of manufacturing a liquid crystal-polymer comprises: evenly mixing liquid crystal microcapsules with a curable sealant to form the liquid crystal-polymer.

Compared with the prior art, the liquid crystal display does not require the support of dual-glass substrates, via the single glass substrate and the coating of the liquid crystal-polymer layer, thereby improving the transmittance, increasing the light utilization, and being suitable for a device with an extremely rapid response, such as a device of field sequence display mode and so on.

### BRIEF DESCRIPTION OF THE DRAWINGS

In order to more clearly illustrate the embodiments of the present invention or the technical solutions in the prior art, the following briefly introduces the accompanying drawings used in the embodiments. Obviously, the drawings in the following description merely show some of the embodiments of the present invention. As regards one of ordinary skill in the art, other drawings can be obtained in accordance with these accompanying drawings without making creative efforts.

FIG. 1 is the basic structure of various categories of the liquid crystal display panels in the background art;

FIG. 2 is a schematic diagram of a liquid crystal display panel in an embodiment of the present invention;

FIG. 3A is a schematic diagram of a glass substrate in an embodiment of the present invention;

FIG. 3B is a schematic diagram of another glass substrate in another embodiment of the present invention;

FIG. 4A is an orientation schematic diagram of liquid crystals in a non-voltage applied state in an embodiment of the present invention;

FIG. 4B is an orientation schematic diagram of liquid crystals in a voltage applied state in an embodiment of the present invention; and

FIG. 5 is a flowchart of a manufacturing method of a liquid crystal display panel in the second embodiment of the present invention.

### DETAILED DESCRIPTION OF THE PREFERRED EMBODIMENTS

Please refer to the figures in the accompany drawings. The components with the same reference numbers represent the same components. The following description is based on the illustrated specific embodiments of the present invention, and should not be construed to limit the other specific embodiments which are not described in detail herein in the present invention.

### First Embodiment

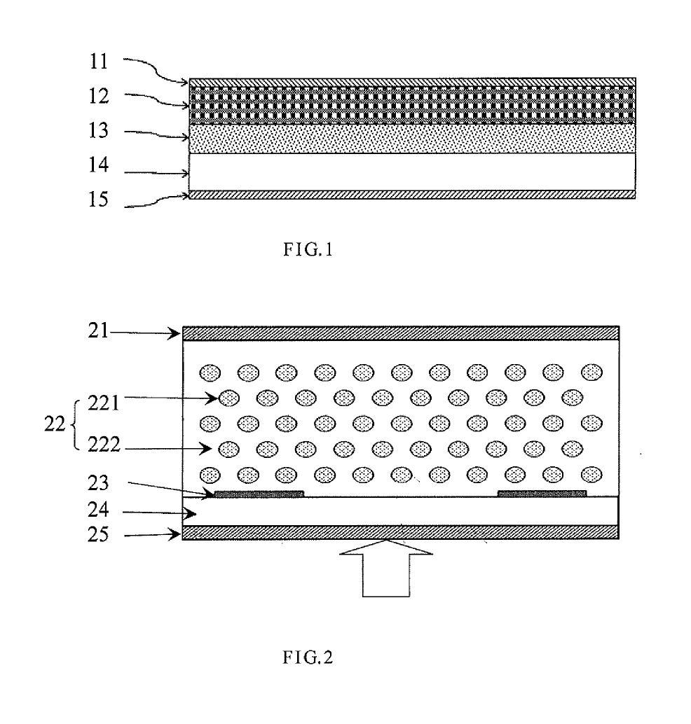

Please refer to FIG. 2, which is a schematic diagram of a liquid crystal display panel in an embodiment of the present invention. The liquid crystal panel sequentially includes an upper polarizer 21, a liquid crystal-polymer layer 22, a glass substrate 24, and a lower polarizer 25.

Comb-like electrodes 23 formed from pixel electrodes and common electrodes in a comb shape, data lines, scanning lines, TFT switches, and a black array (the rest not shown) are disposed on the glass substrate 24; and the comb-like electrodes 23 are used to generate a horizontal electric field.

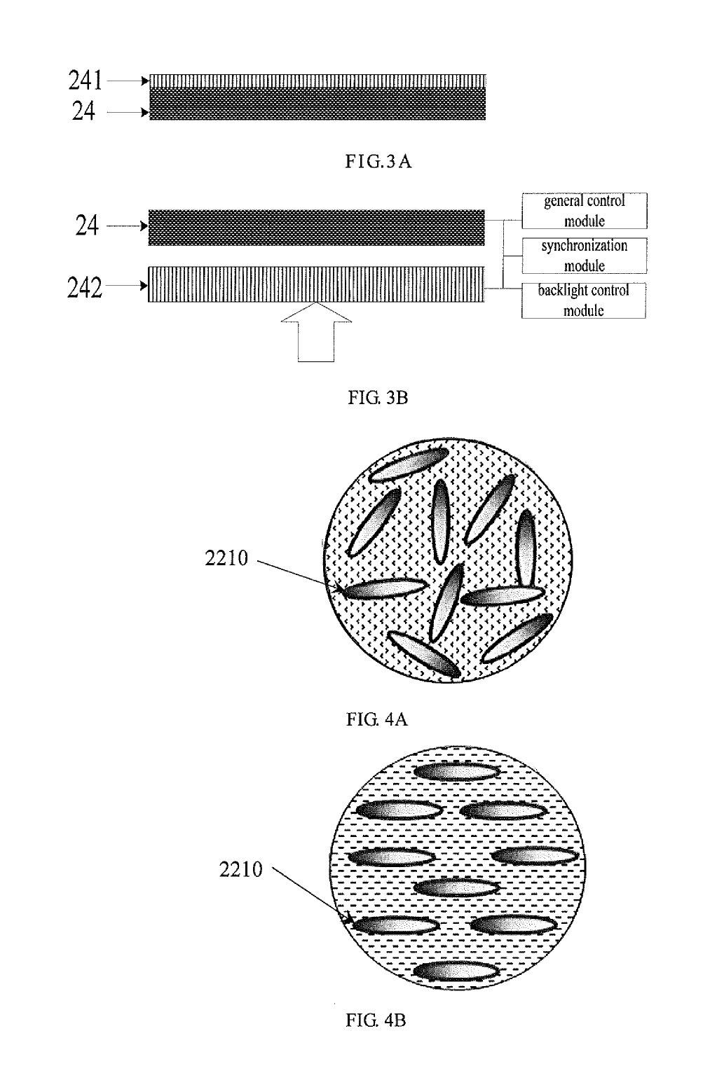

A color filter film 241 as shown in FIG. 3A and a dynamic flashing backlight module 242 as shown in FIG. 3B are disposed on the glass substrate 24 for displaying color.

As shown in FIG. 2 in conjunction with FIG. 3A, the color filter film 241 is disposed on the glass substrate 24, and more specifically is disposed between the glass substrate 24 and the liquid crystal-polymer layer 22, or between the glass substrate 24 and the lower polarizer 25.

As shown in FIG. 2 in conjunction with FIG. 3B, when the color filter film 241 is not disposed on the glass substrate 24, the dynamic flashing backlight module 242 is disposed on the side close to light resource. The dynamic flashing backlight module 242 also includes a general control module, a backlight control module, and a synchronization module of the liquid crystal display panel for receiving control signals and synchronization signals of the display panel and the backlight module.

The liquid crystal-polymer layer 22 is coated on the glass substrate 24.

The liquid crystal-polymer layer 22 contains liquid crystal particulates, and liquid crystal-polymer layer 22 is formed by mixing liquid crystal microcapsules 221 with a UV (ultraviolet rays) curable sealant, and coated and cured by ultraviolet ray irradiation.

Specifically, the size of the liquid crystal microcapsules 221 is 20 nm-200 nm, the exterior thereof is a polymer hard shell, and the interior thereof contains the liquid crystal molecules randomly arranged with each other. The liquid crystal microcapsules 221 are evenly mixed with UV curable sealant 222 by the proportion of 10 to 50%. The liquid crystal-polymer layer 22 is coated on a display area of the substrate by slit coating. Through UV ray irradiation, the sealant 222 is cured to form a polymer layer, thereby encapsulating the liquid crystal molecules in the polymer coated layer.

It should be appreciated that the liquid crystals are formed into capsules, and the polymer mixed with the liquid crystals has great viscosity. Therefore, the support of two substrates is no longer required, and the function of the liquid crystal cell can be achieved.

The upper polarizer 21 and the lower polarizer 25 are respectively attached to the outer sides of the liquid crystal-polymer layer 22 of the glass substrate 24.

It should be understood that the upper polarizer 21 on the side close to human eyes can be regarded as an analyzer. The lower polarizer 25 on the side close to the light source can be regarded as a polarizer.

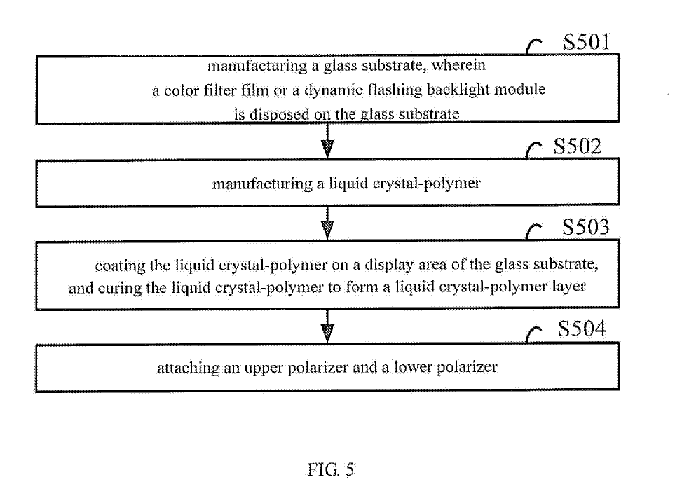

In a non-operating state, no voltage is not applied to the liquid crystal display panel, and the liquid crystal molecules 2210 are in a random orientation state, as shown in FIG. 4A. After going through the lower polarizer 25, the backlight goes through the liquid crystal layer without causing phase difference, and then goes through the upper polarizer in a vertical direction, resulting in a dark state. In an operating state, after a voltage is applied to the comb-like electrodes, the liquid crystal molecules 2210 are deflected under the action of the horizontal electric field, causing phase difference, as shown in FIG. 4B. The backlight can go through the vertical polarizer.

The liquid crystal display panel of the present invention utilizes a single glass substrate, and the coating of the liquid crystal-polymer layer, without the support of dual-substrates, thereby improving transmittance, increasing light utilization, and being suitable for a device with an extremely rapid response, such as a device of field sequence display mode and so on.

### Second Embodiment

Refer to FIG. 5, which shows a manufacturing method of the liquid crystal display panel. The manufacturing method comprises the following steps, and it should be understood that the steps may not have any sequence, or may be performed simultaneously or in a reversed sequence during manufacture:

In step S501, a glass substrate is manufactured, and a color filter film or a dynamic flashing backlight module is disposed on the glass substrate.

It should be understood that the color filter film is disposed between the glass substrate and the liquid crystal-polymer layer, or between the glass substrate and the upper polarizer.

The dynamic flashing backlight module is located on a side close to a light source, and comprises a general control module, a backlight control module, and a synchronization module of the liquid crystal display panel.

In addition, comb-like electrodes formed from pixel electrodes and common electrodes in a comb shape, data lines, scanning lines, TFT switches, and a black array are disposed on the glass substrate.

In step S502, a liquid crystal-polymer is manufactured.

The liquid crystal-polymer is formed by mixing liquid crystal microcapsules with a curable sealant. For example, the size of the liquid crystal microcapsules is 20 nm-200 nm, the exterior thereof is a polymer hard shell, and the interior thereof contains the liquid crystal molecules randomly arranged. The liquid crystal microcapsules 221 are evenly mixed with a UV curable sealant 222 in the proportion of 10% to 50%.

In step S503, the liquid crystal-polymer is coated on a display area of the glass substrate, and is cured to form the liquid crystal-polymer layer after UV ray irradiation.

The mixture of the liquid crystal microcapsules and the curable sealant is coated on the display area on the substrate by slit coating. Through the irradiation of a UV lamp, the sealant is cured to form a liquid crystal-polymer layer,

In step S504, an upper polarizer and a lower polarizer are respectively attached to the outer sides of the liquid crystal-polymer layer and the glass substrate.

It should be understood that the upper polarizer, on the side close to human eyes, can be regarded as an analyzer. The lower polarizer, on the side close to the light source, can be regarded as a polarizer.

In a non-operating state, no voltage is not applied to the liquid crystal display panel, and the liquid crystal molecules 2210 are in a random orientation state, as shown in FIG. 4A. After going through the lower polarizer 25, the backlight goes through the liquid crystal layer without causing phase difference, and then goes through the upper polarizer in a vertical direction, resulting in a dark state. In an operating state, after a voltage is applied to the comb-like electrodes, the liquid crystal molecules 2210 are deflected under the action of the horizontal electric field, causing phase difference, as shown in FIG. 4B. The backlight can go through the vertical polarizer.

The liquid crystal display panel of the present invention utilizes a single glass substrate, and the coating of the liquid crystal-polymer layer, without the support of dual-substrates, thereby improving transmittance, increasing light utilization, and being suitable for a device with an extremely rapid response, such as a device of field sequence display mode and so on.

It should be understood that though various embodiments have different emphases, the designing concepts are the same. For the parts which are not described in detail in a certain embodiment, please refer to the detailed description in the full text of the specification, which are not described redundantly.

In summary, although the preferable embodiments of the present invention have been disclosed above, the embodiments are not intended to limit the present invention. A person of ordinary skill in the art, without departing from the spirit and scope of the present invention, can make various modifications and variations. Therefore, the scopes of the invention are defined in the claims.

What is claimed is:

1. A liquid crystal display panel, comprising:
a glass substrate on which a comb-like electrode formed from a pixel electrode and a common electrode in a comb shape is disposed for generating a horizontal electric field, and a color filter film or a dynamic flashing backlight module is disposed;
a liquid crystal-polymer layer formed by mixing a curable sealant with liquid crystal microcapsules, coated on the glass substrate, and cured by ultraviolet ray irradiation; and
an upper polarizer and a lower polarizer respectively attached to outer sides of the liquid crystal-polymer layer and the glass substrate.

2. The liquid crystal display panel as claimed in claim 1, wherein the color filter film is disposed between the glass substrate and the liquid crystal polymer layer, or between the glass substrate and the upper polarizer.

3. The liquid crystal display panel as claimed in claim 1, wherein the dynamic flashing backlight module is located on a side close to a light source.

4. A liquid crystal display panel, comprising:
a glass substrate on which a color filter film or a dynamic flashing backlight module is disposed;
a liquid crystal-polymer layer coated on the glass substrate; and
an upper polarizer and a lower polarizer respectively attached to the outer sides of the liquid crystal-polymer layer and the glass substrate.

5. The liquid crystal display panel as claimed in claim 4, wherein the color filter film is disposed between the glass substrate and the liquid crystal polymer layer, or between the glass substrate and the upper polarizer.

6. The liquid crystal display panel as claimed in claim 4, wherein the dynamic flashing backlight module is located on a side close to a light source.

7. The liquid crystal display panel as claimed in claim 4, wherein a comb-like electrode formed from a pixel electrode and a common electrode in a comb shape is disposed on the glass substrate for generating a horizontal electric field.

8. The liquid crystal display panel as claimed in claim 4, wherein the liquid crystal-polymer layer is formed by mixing a curable sealant with liquid crystal microcapsules, coated and cured by ultraviolet ray irradiation.

9. A method for manufacturing a liquid crystal display panel, comprising steps of:
manufacturing a glass substrate on which a color filter film or a dynamic flashing backlight module are disposed;
manufacturing a liquid crystal-polymer;
forming a liquid crystal-polymer layer by coating the liquid crystal-polymer on a display area of the glass substrate, and curing the liquid crystal-polymer by ultraviolet ray irradiation; and
attaching an upper polarizer and a lower polarizer respectively to outer sides of the liquid crystal-polymer layer and the glass substrate.

10. The method as claimed in claim 9, wherein the step of disposing the color filter film on the substrate comprises: disposing the color filter film between the glass substrate and the liquid crystal-polymer layer, or between the glass substrate and the upper polarizer.

11. The method as claimed in claim 10, wherein the step of disposing the dynamic flashing backlight module on the substrate comprises: disposing the dynamic flashing backlight module on a side close to a light source, wherein the dynamic flashing backlight module comprises a general control module, a backlight control module, and a synchronization module of the liquid crystal display panel.

12. The method as claimed in claim 10, wherein the step of manufacturing the glass substrate comprises: disposing a comb-like electrode formed from a pixel electrode and a common electrode in a comb shape in the glass substrate, wherein the comb-like electrode is used for generating a horizontal electric field.

13. The method as claimed in claim 9, wherein the step of manufacturing the liquid crystal-polymer comprises: evenly mixing liquid crystal microcapsules with a curable sealant to form the liquid crystal-polymer.
